(19) United States
(12) Patent Application Publication
(10) Pub. No.: US 2005/0041884 A1
(43) Pub. Date: Feb. 24, 2005

(54) System and method of sectioning digital images

(76) Inventors: Jing-Shun Lin, Wujie Township (TW); Chao-Lien Tsai, Jhushan Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/899,222

(22) Filed: Jul. 26, 2004

(30) Foreign Application Priority Data
Jul. 30, 2003 (TW) 92120745

(51) Int. Cl. G06K 9/32; G06K 9/34; G01D 9/00; A63F 9/08

(52) U.S. Cl. 382/276; 346/31; 273/156; 382/173

(57) ABSTRACT

An apparatus for sectioning digital images dynamically in a digital image capture device. The inventive apparatus includes an image capture unit, an image decoding unit, an image processing unit, a section production unit, and a game execution unit. The image capture unit obtains original image data. The image decoding unit decodes the original image data as decoded image data. The image processing unit processes the decoded image data to obtain initial image section data. The section production unit converts the initial image section data to produce final image section data. The game execution displays the final image section data on an image display device for executing a game corresponding to the final image section data.

### BACKGROUND OF THE INVENTION

1. Field of the Invention

The present invention relates to image manipulation technology, and in particular to an apparatus for sectioning digital images dynamically in a digital image capture device.

2. Description of the Related Art

Generally speaking, digital images can be processed into a jigsaw or panel-type puzzle by a computer or other image data processing device. A computer or an image data processing device renders and processes the image data, and sections the processed image data accordingly. One related apparatus is disclosed in U.S. Pat. No. 5,643,084 “Moving Video Jigsaw Puzzle.”

Presently, digital image capture devices are varied. Except for some devices designed especially for image capture, such as digital cameras or digital video cameras, some electric communication devices also have an image capture function, such as mobile phones or personal digital assistants (PDA). Thus, if the image capture function in a digital image capture device can be utilized to produce a game according to the captured images, the entertainment value of a digital image capture device will be enhanced. Present digital image capture devices however cannot provide the mentioned function.

### SUMMARY OF THE INVENTION

Accordingly, an object of the invention is to provide an apparatus and method to section images in a digital image capture device. Digital image capture devices are characterized by real-time image capture capability. The invention utilizes a character to produce a game and provides the game to a user for execution on an on screen display (OSD).

To achieve the foregoing and other objects, the invention is directed to novel systems and methods for overcoming conventional game production problems of image capture devices. The invention provides an apparatus for sectioning digital images dynamically in a digital image capture device. The inventive apparatus comprises an image capture unit, an image decoding unit, an image processing unit, a section production unit, and a game execution unit. The image capture unit obtains original image data. The image decoding unit decodes the original image data as decoded image data. The image processing unit processes the decoded image data to initial image section data. The section production unit converts the initial image section data to final image section data. The game execution unit displays the final image section data on a display device for executing a game.

### BRIEF DESCRIPTION OF THE DRAWINGS

The present invention can be more fully understood by reading the subsequent detailed description and examples with references made to the accompanying drawings, wherein:

FIG. 1 is a diagram of the apparatus for sectioning digital image data dynamically in a digital image capture device.

FIG. 2 is a flowchart of the method for sectioning digital image data dynamically in a digital image capture device.

FIG. 3 is a flowchart of the image data processing of the method for sectioning digital image data dynamically in a digital image capture device.

FIG. 4 is a flowchart of the image data conversion of the method for sectioning digital image data dynamically in a digital image capture device.

FIG. 5 is a diagram of one implementation of the method for sectioning digital image data dynamically in a digital image capture device according to the present invention.

FIG. 6 is a diagram of another implementation of the method for sectioning digital image data dynamically in a digital image capture device according to the present invention.

FIG. 7 is a diagram of one application of the apparatus for sectioning digital image data dynamically in a digital image capture device according to the present invention.

FIG. 8 is a diagram of another application of the apparatus for sectioning digital image data dynamically in a digital image capture device according to the present invention.

### DETAILED DESCRIPTION OF THE INVENTION

As summarized above, the present invention is directed to novel systems and methods for overcoming conventional game production problems in digital image capture devices. In one embodiment, the invention provides an apparatus for sectioning digital images dynamically in a digital image capture device. The digital image capture device may be a digital camera, a digital video camera, a mobile phone, or a PDA. The inventive apparatus includes an image capture unit, an image decoding unit, an image processing unit, a section production unit, and a game execution unit.

The image capture unit obtains original image data. The original image data can be images captured by the digital image capture device or images stored therein. In addition, the original image data can be external images linked to the digital image capture device, such as plug-in memory cards. The image decoding unit decodes the original image data as decoded image data. The original image data is decoded in some standard image data format, such as Joint Photographic Experts Group (JPEG) or Motion Picture Expert Group (MPEG).

The image processing unit processes the decoded image data to initial image section data. The image processing unit includes a resolution adjusting unit and an image data storing unit. The resolution adjusting unit adjusts the resolution of the decoded image data to the initial image section data. The image data storing unit stores the initial image section data to a game buffer in the digital image capture device. The initial image section data is the raw data for producing a game. The stored initial image section data can be accessed for game production or other application.

Because the common resolution format of LCD (Liquid Crystal Display) or TV is not the same as the resolution format adopted in a digital image capture device, thus, the resolution of the image data has to be adjusted for format matching. As an example, the common LCD resolution format is 720×240 pixel, formulated by NTSC (National Television System Committee) or 720×228 pixel, formulated by PAL (Phase Alternation Line). However, the resolution of TFT (Thin Film Transistor) used in a digital camera is 312×220 pixel.

The section production unit includes an image rendering unit, an image dividing unit, and a sorting unit. The image rendering unit renders the initial image section data from a game buffer in the digital image capture device. The image dividing unit divides the initial image section data. The sorting unit sorts the divided initial image section data randomly to produce the final section image data.

The game execution unit displays the final image section data on a display device for executing a game corresponding to the final image section data, such as a jigsaw or panel-type puzzle. The display device may be built in the digital image capture device, such as a display of digital camera or a PDA. The display device also can be a display device connected to the digital image capture device, such as one display of a computer or TV.

The game execution unit comprises a keystroke receiving unit, a key function execution unit, and a determination unit. The keystroke receiving unit receives a keystroke. One keystroke corresponds to one key function, such as right, left, up, or down, for executing a game displayed on the display device. The keystroke can correspond to a key on the digital image capture device or correspond to a key on an external input device connected to the digital image capture device. The key function execution unit executes the key function according to the received keystroke. The determination unit determines if the game is finished. If the game is finished, the determination unit terminates the game.

As mentioned above, the present inventive apparatus processes real-time captured images or external images to produce sectioned images for executing a game. The game corresponding to the sectioned images is specific and can be executed on a display in the digital image capture device or an external display. If the applied digital image capture device is a digital camera, the invention provides significant practicality.

Furthermore, the invention discloses a method of sectioning digital images dynamically in a digital image capture device. The method first obtains original image data. Here, again, the original image data may be obtained from various sources, such as images captured by the digital image capture device, images stored in the digital image capture device, or external images linked to the digital image capture device. The original image data is then decoded as decoded image data.

Next, the decoded image data is processed to initial image section data. The processing comprises certain steps. First, the resolution of the decoded image data is adjusted for format matching to the initial image section data. The initial image section data is then stored in the digital image capture device. Carrying on, the initial image section data in the digital image capture device is rendered, divided and sorted randomly to produce the final image section data. The method of division depends on the desired game, such as a jigsaw puzzle, sliding panel, or tangram.

Finally, the final image section data is displayed for executing a game. For example, the final image section data may be displayed in an image display device. The image display device can be a built-in display in the digital image capture device or an external display, such as a display on a TV or computer.

The detailed steps of game execution are as follows. First, a keystroke is received, wherein the keystroke corresponds to a key function for executing a game. The key function is executed according to the received keystroke. If the game is finished or the game user desires to terminate the game, it is then terminated. The keystroke may correspond to a key on the digital image capture device or a key on an external input device, such as a keyboard, connected to the digital image capture device. Here, the key functions are designed according to the desired game.

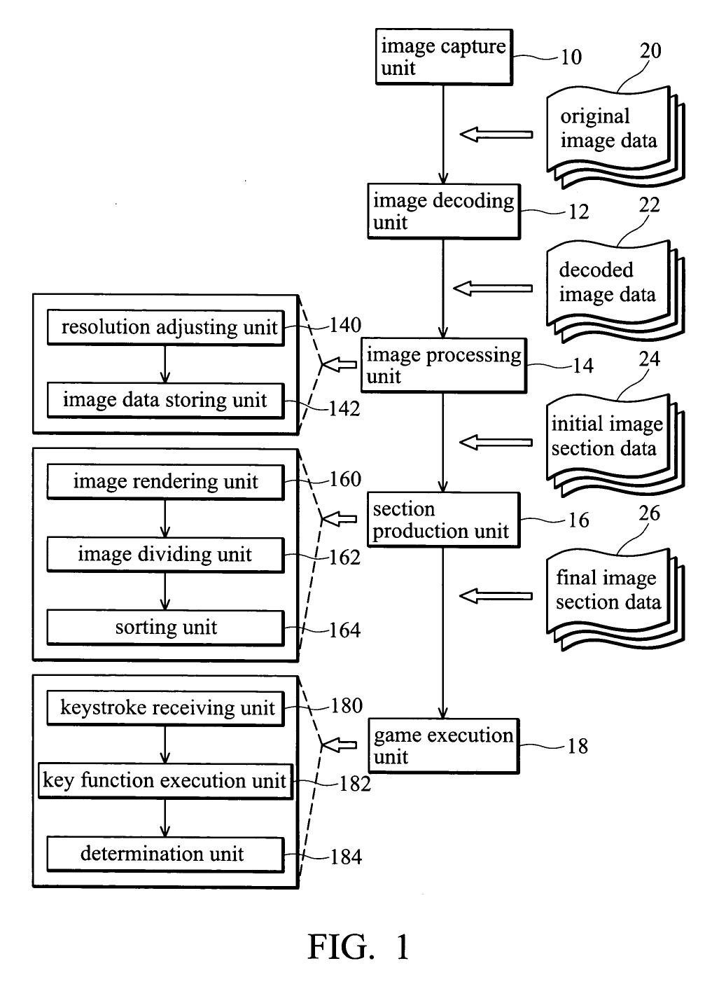

FIG. 1 is a diagram of the apparatus for sectioning digital image data dynamically in a digital image capture device. The disclosed apparatus includes an image capture unit 10, an image decoding unit 12, an image processing unit 14, a section production unit 16, and a game execution unit 18.

The image capture unit 10 obtains original image data 20. The original image data 20 may be images captured by the digital image capture device or images stored in the digital image capture device. The original image data 20 may also be external images linked to the digital image capture device. The image decoding unit 12 decodes the original image data 20 as decoded image data 22. The original image data 20 is defined in some image data standard format, such as JPEG, or MPEG.

The image processing unit 14 processes the decoded image data 22 into initial image section data 24. The image processing unit 14 includes a resolution adjusting unit 140 and an image data storing unit 142. The resolution adjusting unit 140 adjusts the resolution of the decoded image data 22 to the initial image section data. 24. The image data storing unit 142 stores the initial image section data 24 in the digital image capture device.

The section production unit 16 converts the initial image section data 24 to final image section data 26. The section production unit 16 includes an image rendering unit 160, an image dividing unit 162, and a sorting unit 164. The image rendering unit 160 renders the initial image section data 24 in the digital image capture device. The image dividing unit 162 divides the initial image section data 26. The sorting unit 164 sorts the divided initial image section data 24 randomly to produce the final image section data 26.

The game execution unit 18 displays the final image section data 26 on a display device for executing a game.

The game execution unit 18 comprises a keystroke receiving unit 180, a key function execution unit 182, and a determination unit 184. The keystroke receiving unit 180 receives a keystroke. One keystroke corresponds to one key function, such as right, left, up, or down, for game execution. The keystroke corresponds to a key on the digital image capture device or corresponds to a key on an external input device connected to the digital image capture device. The key function execution unit 182 executes the key function according to the received keystroke. The determination unit 184 determines if the executed game is finished. If the game is finished or the game user desires to terminate thereof, the determination unit 184 terminates the game.

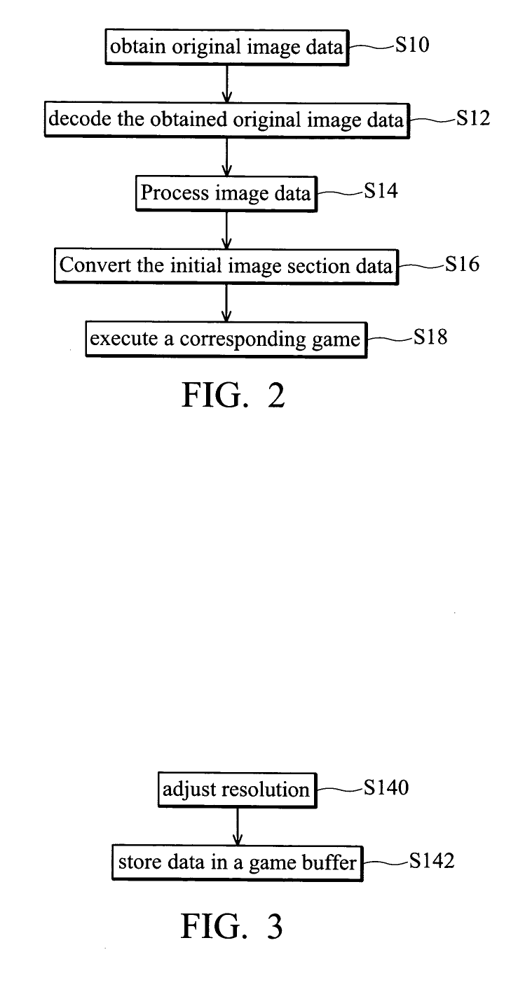

FIG. 2 is a flowchart of the method for sectioning digital image data dynamically in a digital image capture device. The method first obtains original image data (step S10) and decodes the obtained original image data as decoded image data (step S12).

Next, the decided image data is processed to initial image section data (step S14). The detailed steps of image data processing are depicted in FIG. 3. FIG. 3 is a flowchart of the image data processing of the method for sectioning digital image data dynamically in a digital image capture device. The resolution of the decoded image data is first adjusted to the initial image section data (step S140). The initial image section data is then stored (step S142) in the digital image capture device.

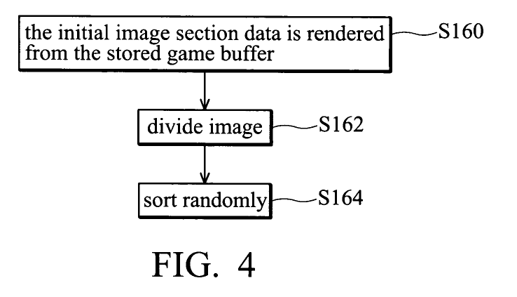

Afterward, the initial image section data is converted to final image section data (step S16). FIG. 4 is a flowchart of the image data converting of the method for sectioning digital image data dynamically in a digital image capture device. The initial image section data in the digital image capture device is rendered (step S160), divided (step S162), and sorted randomly (step S164) to produce the final image section data.

Finally, the final image section data is displayed on a display device for executing a corresponding game (step S18). The display device can be a built-in display or an external display, such as a display on a TV or computer.

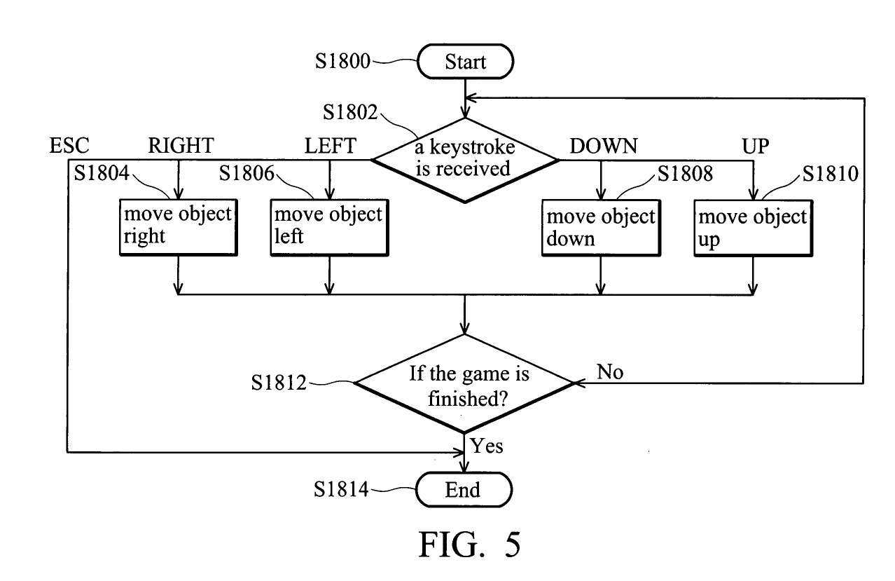

FIG. 5 is a diagram of one implementation of the method for sectioning digital image data dynamically in a digital image capture device according to the present invention. In one implementation, the produced image game is a sliding panel. The detailed steps of game execution are as follows. First, the game is executed (step S1800) and a keystroke is received (step S1802). Next, the key function is executed according to the received keystroke (step S1804, S1806, S1808, S1810). For example, the ESC key terminates the game, the RIGHT key moves the object right. If the game is finished, (step S1812) it is then terminated (step S1814).

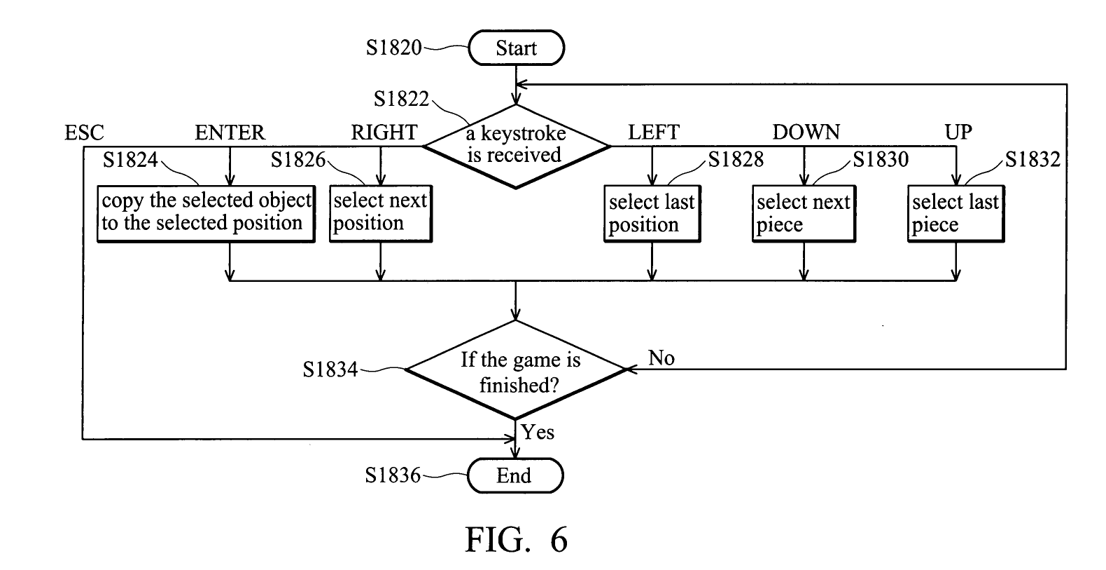

FIG. 6 is a diagram of another implementation of the method for sectioning digital image data dynamically in a digital image capture device according to the present invention. In another implementation, the executed game is a jigsaw puzzle. The detailed steps of game execution are as follows. First, a game is executed (step S1820) and a keystroke is received (step S1822). Next, the key function is executed according to the received keystroke (step S1824, S1826, S1828, S1830, S1832) . For example, the ESC key terminates the game, the UP key selects one piece, the RIGHT key selects one position, and the ENTER key copies the selected piece to the selected position. If the game is finished (step S1834), it is then terminated (step S1836).

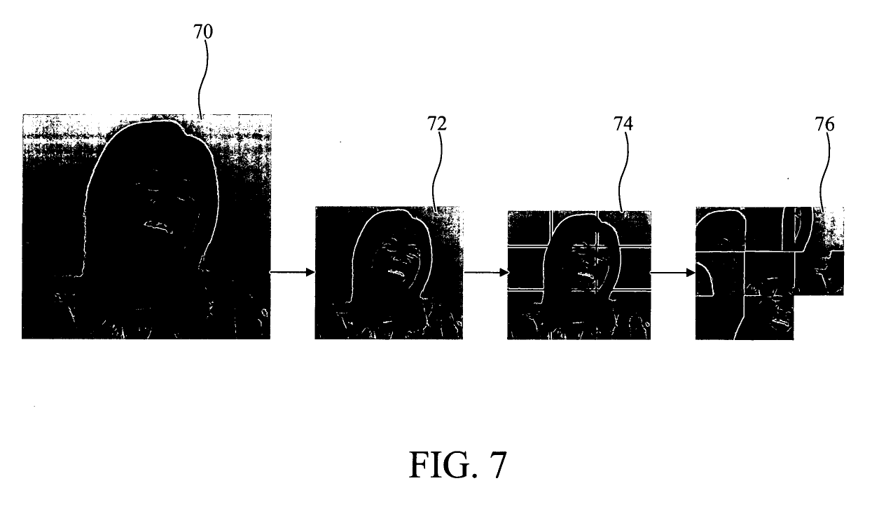

FIG. 7 is a diagram of one application of the apparatus for sectioning digital image data dynamically in a digital image capture device according to the present invention. In one application, the original image data 70 is in JPEG format. The image capture unit obtains the original image data 70.

The image decoding unit decodes the original image data 70 as decoded image data. The image processing unit adjusts the resolution of the decoded image data to produce the initial image section data 72 and stores the initial image section data 72 to a game buffer in the digital image capture device.

The stored initial image section data 72 can be accessed for a game or other application. The section production unit renders the initial image section data 72 from the stored game buffer, divides the initial image section data 72, and sorts the divided initial image section data 74 randomly to produce the final image section data 76. Here, the executed game is a sliding panel, thus, the key functions are object movements, such as right, left, up, or down.

The game execution unit displays the final image section data 76 on a display device. The game execution unit receives a keystroke, corresponding to a key function, and executes the key function according to the received keystroke. The game execution unit will determine if the game is finished. If the game is finished, the game execution unit terminates the game.

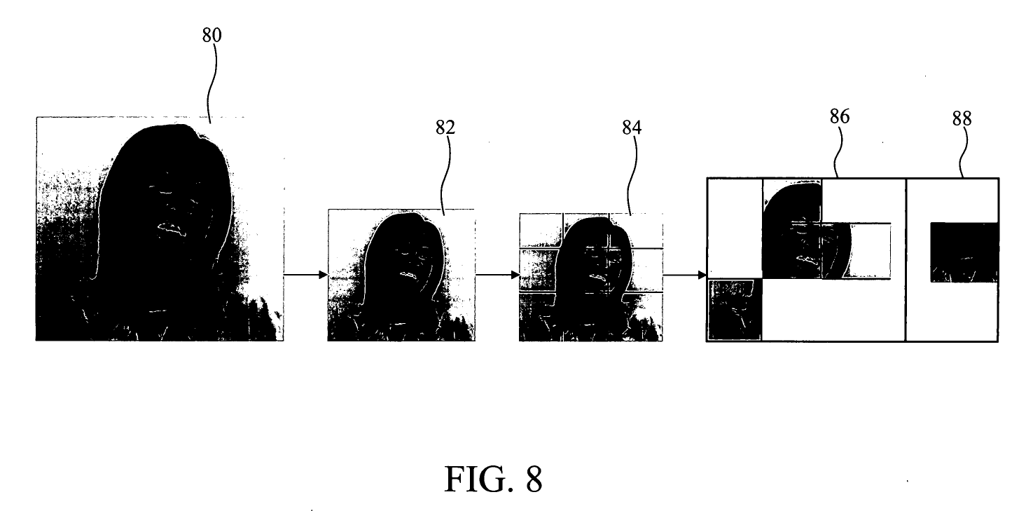

FIG. 8 is a diagram of another application of the apparatus for sectioning digital image data dynamically in a digital image capture device according to the present invention. In another application, the original image data 80 is in JPEG format. The produced image game is a jigsaw puzzle.

Most steps are similar to the mentioned steps. The original image data 80 is obtained, decoded, and adjusted to produce the initial image section data 82. The stored initial image section data 82 is rendered, divided, and sorted randomly to produce the final image section data 86.

The final image section data 86 is displayed on a display device. The game execution unit receives a keystroke, corresponding to a key function, and executes the key function according to the received keystroke. The game execution unit will determine if the game is finished. If the game is finished, the game execution unit terminates the game. Here, the key functions are selection of pieces, selection of positions, or copying of the selected piece to the selected position.

Thus, a method of sectioning digital images dynamically in a digital image capture device is provided by the present invention. Users can capture and produce a desired game real-time in a digital image capture device, presenting significant advantages to image data manipulation.

It will be appreciated from the foregoing description that the system and method described herein provide a dynamic and robust solution to image manipulation problems. If, for example, the produced images are applied to different games, the system and method of the present invention can be revised accordingly.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An apparatus for sectioning digital image dynamically in a digital image capture device, comprising:
an image capture unit, obtaining original image data;
an image decoding unit, coupled to the image capture unit, decoding the original image data as decoded image data;
an image processing unit, coupled to the image decoding unit, processing the decoded image data to initial image section data;
a section production unit, coupled to the image processing unit, converting the initial image section data to final image section data; and
a game execution unit, coupled to the section production unit, displaying the final image section data on an image display device for executing a game corresponding to the final image section data.

2. The apparatus as claimed in claim 1, wherein the digital image capture device is a digital camera.

3. The apparatus as claimed in claim 1, wherein the image capture unit obtains the original image data from the images captured by the digital image capture device.

4. The apparatus as claimed in claim 1, wherein the image capture unit obtains the original image data from the images stored in the digital image capture device.

5. The apparatus as claimed in claim 1, wherein the image capture unit obtains the original image data from external images linked to the digital image capture device.

6. The apparatus as claimed in claim 1, wherein the image processing unit further comprises:
a resolution adjusting unit, adjusting the resolution of the decoded image data to the initial image section data; and
an image data storing unit, coupled to the resolution adjusting unit, storing the initial image section data in a game buffer, wherein the game buffer is in the digital image capture device.

7. The apparatus as claimed in claim 1, wherein the section production unit further comprises:
an image rendering unit, rendering the initial image section data from a game buffer, wherein the game buffer is in the digital image capture device;
an image dividing unit, coupled to the image rendering unit, dividing the initial image section data; and
a sorting unit, coupled to the image dividing unit, sorting the divided initial image section data randomly to produce the final image section data.

8. The apparatus as claimed in claim 1, wherein the image display device is a built-in display device of the digital image capture device.

9. The apparatus as claimed in claim 1, wherein the image display device is a display device connected to the digital image capture device.

10. The apparatus as claimed in claim 1, wherein the game execution unit further comprises:
a keystroke receiving unit, receiving a keystroke, wherein the keystroke corresponds to a key function for executing the game;
a key function execution unit, coupled to the keystroke receiving unit, executing the key function according to the received keystroke; and
a determination unit, coupled to the key function execution unit, determining if the game is finished and terminating the game when the game is finished.

11. The apparatus as claimed in claim 10, wherein the keystroke corresponds to a key on the digital image capture device.

12. The apparatus as claimed in claim 10, wherein the keystroke corresponds to a key on an external input device connected to the digital image capture device.

13. A method for sectioning digital images dynamically in a digital image capture device, comprising the steps of:
obtaining original image data;
decoding the original image data as decoded image data;
processing the decoded image data to initial image section data;
converting the initial image data to final image section data; and
displaying the final image section data for executing a game corresponding to the final image section data.

14. The method as claimed in claim 13, wherein the digital image capture device is a digital camera.

15. The method as claimed in claim 13, wherein in the obtaining step, the original image data is obtained from the images captured by the digital image capture device.

16. The method as claimed in claim 13, wherein in the obtaining step, the original image data is obtained from the images stored in the digital image capture device.

17. The method as claimed in claim 13, wherein in the obtaining step, the original image data is obtained from external images linked to the digital image capture device.

18. The method as claimed in claim 13, wherein the processing step further comprises the steps of:
adjusting the resolution of the decoded image data to the initial image section data; and
storing the initial image section data in the digital image capture device.

19. The method as claimed in claim 13, wherein the converting step further comprises the steps of:
rendering the initial image section data in the digital image capture device;
dividing the initial image section data; and
sorting the divided initial image section data randomly to produce the final image section data.

20. The method as claimed in claim 13, wherein the game executing step further comprises the steps of:
receiving a keystroke, wherein the keystroke corresponds to a key function for executing the game;
executing the key function according to the received keystroke; and
determining if the game is finished and terminating the game when the game is finished.
